(19) United States
(12) Patent Application Publication
(10) Pub. No.: US 2012/0250536 A1
(43) Pub. Date: Oct. 4, 2012

(54) ETHERNET-DUAL-ENDED LOSS MEASUREMENT CALCULATION

(75) Inventors: Daniel Lafleur, Kanata (CA); Thu Le, Ottawa (CA)

(73) Assignee: ALCATEL-LUCENT CANADA INC., Ottawa (CA)

(21) Appl. No.: 13/076,646

(22) Filed: Mar. 31, 2011

(51) Int. Cl. H04L 12/26

(52) U.S. Cl. 370/252

(57) ABSTRACT

The invention is directed to a method of preserving accuracy in dual-ended frame loss measurement system between a first node and a second node in a packet switching network, especially by Ethernet routers, switches and bridges supporting ITU-T Y.1731 dual-ended LM functionality by enhancing the behavior of dual-ended frame loss measurement to permit enabling and disabling the loss measurement at each node separately without incurring erroneous errors.

### FIELD OF THE INVENTION

The invention is directed to packet switching communication networks, particularly to dual-ended frame loss measurement calculations in Ethernet networks.

### BACKGROUND OF THE INVENTION

Ethernet has evolved from a local area network technology into a carrier class technology with increases in scalability, standardized services, increased reliability and enhanced management features such as Operation, Administration and Maintenance (OAM) functions.

In the International Telecommunications Union—Telecommunication Standardization Sector (ITU-T) Specification Y.1731, specifying Operation, Administration and Maintenance (OAM) functions and mechanisms for Ethernet based networks, Section 8.1.1 describes the dual-ended Eth-LM (Ethernet Frame Loss Measurement) as a proactive OAM for performance monitoring, applicable to fault management between two Ethernet nodes. The dual-ended Eth-LM functionality uses the Continuity Check Message (CCM) Protocol Data Unit (PDU) to transmit and receive the loss measurement (LM) counters between the two nodes. Those LM counters are used to calculate the Near-End and Far-End loss measurement. The LM calculation is fully described in section 8.1.1.1 and 8.1.1.2 of ITU-T Y.1731 specification and also Appendix III of ITU-T Y1731 specification, both of which are herein incorporated by reference.

Note that ITU-T Y1731 refers to Maintenance Entities (ME), ME groups (MEG) and MEG End points (MEP). For expediency, the present document generalizes MEP as Ethernet nodes. It is understood that the nodes referred to herein support OAM services such as dual-ended loss measurements.

A service provider must have the ability to configure the CCM transmission with or without the proactive dual-ended Eth-LM functionality. When enabled, both nodes exchange the LM counters and the loss measurement calculation is performed. Although the ITU-T Y.1731 specification describes the loss measurement (including LM counters wrap-around), it is assumed that both nodes have been configured simultaneously with dual-ended Eth-LM enabled or disabled. However, dual-ended Eth-LM can be enabled or disabled independently per node and the service provider can decide to change the configuration at any time. Therefore, when dual-ended Eth-LM is enabled on both nodes and the service provider decides to disable the proactive dual-ended Eth-LM on one node, the other node will continue to perform LM calculation, wrongly detect loss frames because the other node is no longer transmitting LM counters within the CCM PDU which might generate false alarms or trigger unnecessary actions such as for example, a fast re-route.

When dual-ended Eth-LM is disabled on one node, the service provider must also disable the dual-ended Eth-LM on the other node. Both nodes cannot be disabled simultaneously therefore, the loss measurement calculation becomes invalid on the node that has dual-ended Eth-LM enabled while the other node has the dual-ended Eth-LM disabled.

The same issue occurs when both nodes have dual-ended Eth-LM disabled and the service provider enables the loss measurement functionality. Since both nodes cannot be enabled simultaneously, one node would be enabled while the other node would still be disabled causing the loss measurement calculation to be invalid.

As soon as the dual-ended Eth-LM configuration is changed, the service provider must apply the same configuration to both nodes. When both nodes have been configured, the service provider must then reset the loss measurement on both nodes (i.e. clearing the LM calculation) which restarts the loss measurement calculation. Thus any time the state of dual-ended loss measurement is changed, invalid measurements are captured thus corrupting ongoing loss measurement statistics.

Therefore, a means of preserving accuracy of dual-ended frame loss measurement would be highly desirable.

### SUMMARY OF THE INVENTION

One aspect of the present invention is directed to a method of preserving accuracy in dual-ended frame loss measurements between a first node and a second node in a packet switching network. The method comprising steps of: receiving at the first node, an indication that loss measurement at the second node is disabled; and stopping loss measurement at the first node.

Some embodiments of the invention further comprise steps of: receiving at the first node, an indication that loss measurement at the second node is enabled; determining at the first node that loss measurement at the first node is ready to calculate; and resuming loss measurement at the first node.

In some embodiments of the invention the step of receiving at the first node an indication that loss measurement at the second node is disabled comprises steps of: receiving at the first node a current message comprising loss measurement counters from the second node; and determining at the first node that the received current loss measurement counters from the second node are invalid.

In some embodiments of the invention the step of stopping loss measurement at the first node further comprises steps of: receiving at the first node a current message comprising loss measurement counters from the second node; invalidating at the first node the current received loss measurement counters; and invalidating at the first node the previous received loss measurement counters.

In some embodiments of the invention the step of receiving at the first node, an indication that loss measurement at the second node is enabled comprises a step of determining at the first node that current received loss measurement counters from the second node are valid; and wherein the step of determining at the first node that loss measurement at the first node is ready comprises a step of determining at the first node that the previous received loss measurement counters from the second node are valid.

In some embodiments of the invention the step of stopping the loss measurement calculations at the first node preserves historical loss measurement statistics at the first node.

In some embodiments of the invention the packet switching network comprises an Ethernet network.

In some embodiments of the invention the dual-ended loss measurement is compliant with International Telecommunications Union—Telecommunication Standardization Sector (ITU-T) Specification Y.1731 (ITU-T Y.1731).

In some embodiments of the invention the received loss measurement counters comprise Ethernet Loss Measurement (LM) counters received within a Continuity Check Message (CCM) from the second node and wherein the step of determining at the first node that the received loss measurement counters are invalid comprises determining at the first node that each the received LM counter has a value of zero.

In some embodiments of the invention the LM counters comprise: TxFCf, RxFCb, and TxFCb and wherein the step of determining at the first node that each the LM counter has a value of zero comprises determining at the first node if TxFCf=RxFCb=TxFCb=0.

In some embodiments of the invention the step of invalidating at the first node the previous received loss measurement counters comprises a step of setting locally stored values at the first node of previous received TxFCf=RxFCb=TxFCb=0.

Another aspect of the present invention provides a program storage device readable by a machine, tangibly embodying a program of instructions executable by the machine to perform the method steps of claim 1.

### BRIEF DESCRIPTION OF THE DRAWINGS

Some embodiments of apparatus and/or methods in accordance with embodiments of the present invention are now described, by way of example only, and with reference to the accompanying drawings in which:

FIG. 1 illustrates a network configuration of two Ethernet nodes for dual-ended loss measurement;

FIG. 2 illustrates a network configuration for dual-ended loss measurement for multiple Ethernet nodes in a Ethernet network; and

FIG. 3 illustrates a method of preserving accuracy in dual-ended frame loss measurement.

In the figures, like features are denoted by like reference characters.

### DETAILED DESCRIPTION

Dual-ended Ethernet frame loss measurement (Eth-LM) is calculated based on current and previous LM counters as described in ITU-T Y.1731 (section 8.1.1). When dual-ended Eth-LM is disabled, the CCM PDU is transmitted with LM counters being set to 0.

Embodiments of the present invention add mechanisms to ITU-T Y.1731 to provide a seamless transition as dual-ended Eth-LM is enabled and disabled individually on each of two nodes in a dual-ended Eth-LM measurement system.

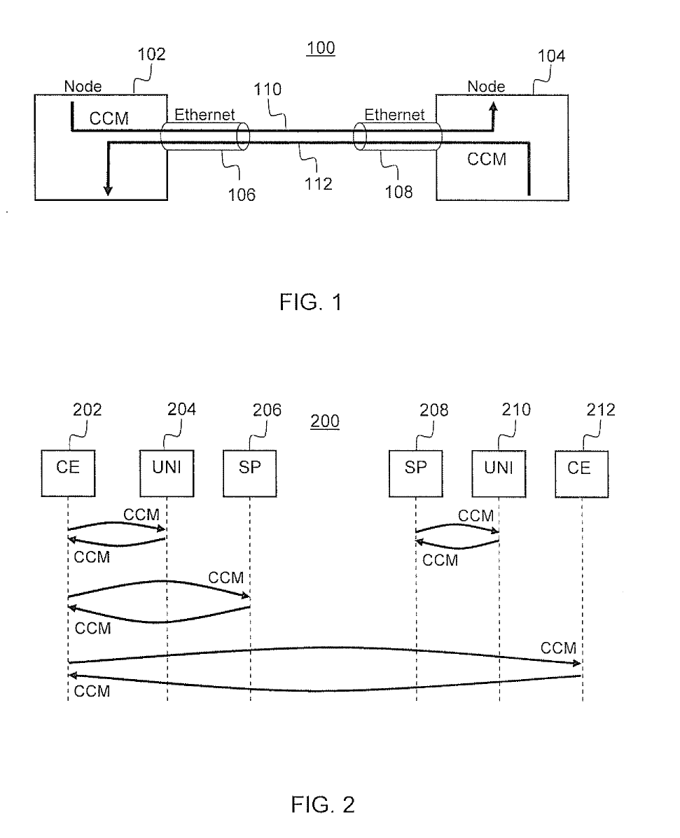

With reference to FIG. 1, packet switching network 100 has a first node 102, and a second node 104 each having an Ethernet interface 106, 108 respectively. Nodes 102, 104 are configured to perform dual-ended Eth-LM between them. First node 102 sends CCM PDUs 110 containing LM counters to second node 104. Second node 104 sends CCM PDUs 112 containing LM counters to first node 102.

FIG. 2 illustrates that the point to point dual-ended Eth-LM process can occur between multiple pairs of nodes in the network 200.

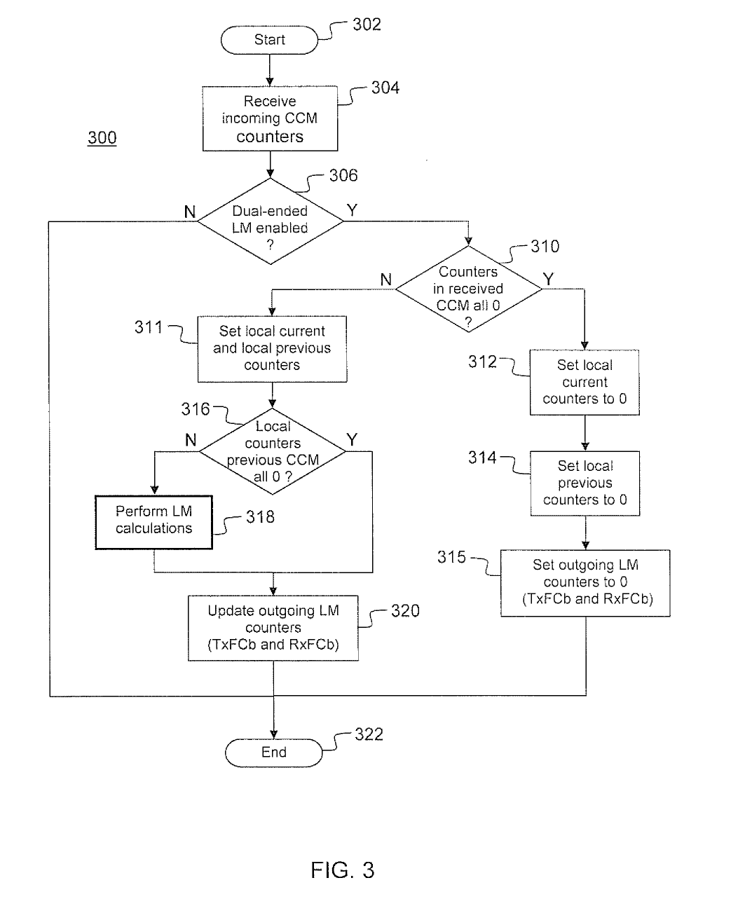

With reference to FIG. 3, process 300 illustrates an embodiment of a method of preserving accuracy in dual-ended frame loss measurement. The process starts at step 302. At step 304, the first node 102 receives incoming CCM counters as described in ITU-T Y.1731 (section 8.1.1).

The loss measurement process uses loss measurement counters in CCM frames received from the second node 104. The rolling frame counts from corresponding counters: TxFCf; RxFCb; and TxFCb from consecutive CCM frames: the current CCM frame; and the previous CCM frame, as well as rolling count from local counter RxFCl of frames received.

Thus the values from the current CCM frame are represented as TxFCf[t_{c}], RxFCb[t_{c}], TxFCb[t_{c}], where t_{c} is the reception time of the current frame, and RxFCl[t_{c}]. The values from the previous CCM frame are represented as TxFCf[tₚ], RxFCb[tₚ], TxFCb[tₚ], where tₚ is the reception time of the previous frame and RxFCl[tₚ] is the value of local counter RxFCl at time tₚ.

At step 306, first node 102 determines if dual-ended loss measurement is enabled at first node 102 and if not the process ends at step 322.

Note that independent of this process, it is the responsibility of the CCM transmitter to set all LM counters to 0 when dual-ended LM is not used to indicate to second node 104 that dual-ended loss measurement is disabled at first node 102.

If at step 306, first node 102 determines that dual-ended loss measurement is enabled the process proceeds to step 310 where first node 102 determines if dual-ended loss measurement is disabled at second node 104, by determining if the counter values from the current CCM frame, TxFCf[t_{c}]=RxFCb[t_{c}]=TxFCb[t_{c}]=zero, in which case the values of these counters are not valid for calculating dual-ended loss measurements at first node 102 which is an indication that loss measurement at second node 104 is disabled and therefore the process proceeds to step 312 where first node 102 sets the local current counters to zero and then proceeds to step 314 where first node 102 sets the local previous counters to zero. The process then continues to step 315 where the outgoing LM counters (i.e. TxFCb and RxFCb) are also updated, by setting them to zero (0). The outgoing CCM frame will be transmitted with the corresponding values. The process ends at step 322.

Note that independent of this process, an outgoing CCM frame is periodically transmitted by the CCM transmitter of first node 102 to second node 104. Another counter, TxFCf is set by the CCM transmitter when the CCM frame is transmitted.

If at step 310 first node 102 determines that TxFCf[t_{c}], RxFCb[t_{c}], and TxFCb[t_{c}] are not all zero, this indicates that dual-ended loss measurement is enabled at second node 104 and the process proceeds to step 311 where the local current and local previous counters are updated. i.e. local previous counters are set to the values of the previous local current counters, and the local current counters are set based on the received CCM counters.

The process then proceeds to step 316 to determine if first node 102 is ready to calculate loss measurements or not by determining if TxFCf[tₚ]=RxFCb[tₚ]=TxFCb[tₚ]=zero. If these counters are all zero then the values of these counters are not valid for calculating dual-ended loss measurements at first node 102. Thus because there are no valid running counters from the previous CCM frame, first node 102 can not calculate the number of frames between consecutive CCM frames. Thus loss measurement is not performed but the process continues to step 320 where the outgoing LM counters (i.e. TxFCb and RxFCb) are updated because the CCM frame being received is valid. The process then ends at step 322.

If at step 316 first node 102 determines that first node 102 is ready to calculate loss measurement by determining that TxFCf[tₚ], RxFCb[tₚ], TxFCb[tₚ] are not all zero, then the process proceeds to step 318, where first node 102 performs dual-ended frame loss measurement calculations per ITU-T Y.1731 (section 8.1.1) and at step 320 first node 102 updates the outgoing loss measurement counters (i.e. TxFCb and RxFCb) for the next outgoing CCM frame. The process then ends at step 322.

Embodiments of the present invention conform to ITU-T Y.1731 while enhancing behavior and improving usability of dual-ended frame loss measurement and could be used by Ethernet nodes such as Router/Bridges/Switches that support ITU-T Y.1731 dual-ended LM functionality.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Numerous modifications, variations and adaptations may be made to the embodiment of the invention described above without departing from the scope of the invention, which is defined in the claims.

What is claimed is:

1. A method of preserving accuracy in dual-ended frame loss measurements between a first node and a second node in a packet switching network, the method comprising steps of:
receiving at said first node, an indication that loss measurement at said second node is disabled; and
stopping loss measurement at said first node.

2. The method of claim 1 further comprising steps of:
receiving at said first node, an indication that loss measurement at said second node is enabled;
determining at said first node that loss measurement at said first node is ready to calculate; and
resuming loss measurement at said first node.

3. The method of claim 2 wherein said step of receiving at said first node, an indication that loss measurement at said second node is disabled comprises steps of:
receiving at said first node a current message comprising loss measurement counters from said second node; and
determining at said first node that said received current loss measurement counters from said second node are invalid.

4. The method of claim 3 wherein said step of stopping loss measurement at said first node further comprises steps of:
receiving at said first node a current message comprising loss measurement counters from said second node;
invalidating at said first node said current received loss measurement counters; and
invalidating at said first node said previous received loss measurement counters.

5. The method of claim 4 wherein said step of receiving at said first node, an indication that loss measurement at said second node is enabled comprises a step of determining at said first node that current received loss measurement counters from said second node are valid; and wherein said step of determining at said first node that loss measurement at said first node is ready comprises a step of determining at said first node that said previous received loss measurement counters from said second node are valid.

6. The method of claim 5 wherein said step of stopping said loss measurement calculations at said first node preserves historical loss measurement statistics at said first node.

7. The method of claim 6 wherein said packet switching network comprises an Ethernet network.

8. The method of claim 7 wherein said dual-ended loss measurement is compliant with International Telecommunications Union—Telecommunication Standardization Sector (ITU-T) Specification Y.1731 (ITU-T Y.1731).

9. The method of claim 8 wherein said received loss measurement counters comprise Ethernet Loss Measurement (LM) counters received within a Continuity Check Message (CCM) from said second node and wherein said step of determining at said first node that said received loss measurement counters are invalid comprises determining at said first node that each said received LM counter has a value of zero.

10. The method of claim 9 wherein said LM counters comprise: TxFCf, RxFCb, and TxFCb and wherein said step of determining at said first node that each said LM counter has a value of zero comprises determining at said first node if TxFCf=RxFCb=TxFCb=0.

11. The method of claim 10 wherein said step of invalidating at said first node said previous received loss measurement counters comprises a step of setting locally stored values at said first node of previous received TxFCf=RxFCb=TxFCb=0.

12. A program storage device readable by a machine, tangibly embodying a program of instructions executable by the machine to perform the method steps of claim 1.
